(19) United States
(12) Patent Application Publication
(10) Pub. No.: US 2012/0092165 A1
(43) Pub. Date: Apr. 19, 2012

(54) Digital Disc Alarm

(76) Inventor: Mary L. Jones, Athens, TX (US)

(21) Appl. No.: 12/903,483

(22) Filed: Oct. 13, 2010

(51) Int. Cl. G08B 13/14; B23P 19/04

(52) U.S. Cl. 340/571; 29/428

(57) ABSTRACT

An alarm for digital storage discs includes an alarm module positioned within the central indention found in conventional CD and DVD jewel cases. A lid sensor in communication with the alarm module includes a pair of spaced trigger arms that form an ovate opening. A nodule on the uppermost arm engages the jewel case lid to maintain engagement of electrical contacts on the arms. An arming switch includes a magnetically-operated pin that is extended into the opening formed between the triggers to prevent the contacts from separating. Once the jewel case is sealed, an arming station initially retracts the pin while the case lid firmly engages the nodule to maintain the contacts in engagement. If an unauthorized user opens the jewel case without first extending the pin at the arming station, the triggers will automatically separate thereby activating the alarm.

### BACKGROUND OF THE INVENTION

The present invention relates to an alarm for preventing theft of digital storage discs such as DVD's and CD's.

### DESCRIPTION OF THE PRIOR ART

Retailers suffer tremendous losses each year due to thefts of compact discs (CD's) and digital versatile discs (DVD's). Often, the disc jewel cases are enclosed within a theft-prevention frame that triggers an alarm if not removed by store personnel prior to the case passing a scanner. However, in order to circumvent the conventional alarm, thieves will remove the disc from the packaging and simply escape with the disc. Accordingly, there is currently a need for an improved alarm that prevents thieves from removing the disc from its packaging. The present invention addresses this need by providing an alarm that is activated whenever a jewel case is opened to alert those nearby of a possible theft.

### SUMMARY OF THE INVENTION

The present invention relates to an alarm for digital storage discs including an alarm module positioned within the central indention typically found in conventional CD and DVD jewel cases. A lid sensor in communication with the alarm module includes a pair of spaced trigger arms that form an ovate opening

A nodule on the uppermost arm engages the jewel case lid to maintain engagement of electrical contacts on the arms. An arming switch includes a magnetically-operated pin that is extended into the opening formed between the triggers to prevent the contacts from separating. Once the jewel case is sealed, an arming station initially retracts the pin while the case lid firmly engages the nodule to maintain the contacts in engagement. If an unauthorized user opens the jewel case without first extending the pin at the arming station, the triggers arms will automatically separate thereby activating the alarm.

It is therefore an object of the present invention to provide an alarm for preventing theft of digital data storage discs.

It is another object of the present invention to provide an alarm system that automatically alerts those nearby whenever a digital disc jewel case is opened by an unauthorized person.

Other objects, features, and advantages of the present invention will become readily apparent from the following detailed description of the preferred embodiment when considered with the attached drawings and the appended claims

### BRIEF DESCRIPTION OF THE DRAWINGS

FIG. 1 is a top view of a typical digital-disc jewel case.

FIG. 2 is a top view of the case of FIG. 1 with the alarm according to the present invention installed therein.

FIG. 3 is an isolated, view of the alarm module.

FIG. 4 is an isolated, view of the lid sensor and arming switch.

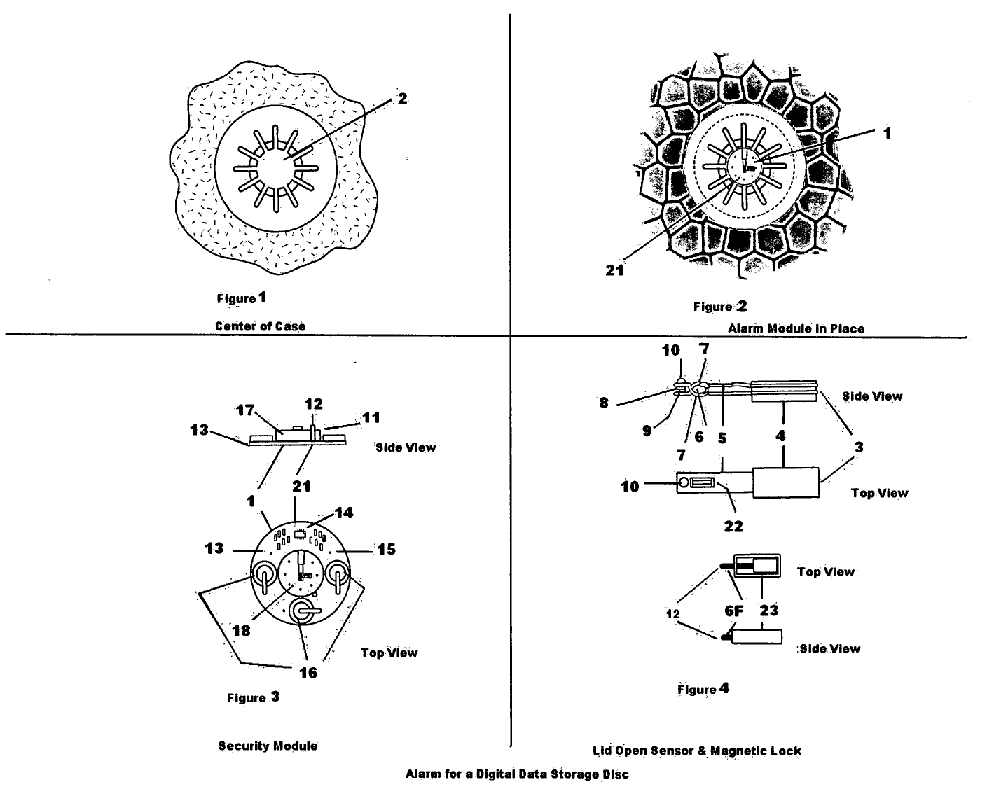

### DESCRIPTION OF THE PREFERRED EMBODIMENT

The present invention relates to an alarm for digital storage discs including an alarm module 1 formed of a circuit board having a piezo buzzer and microcontroller. The circuit board is substantially circular and is unobtrusively positioned within the central indention 2 found in conventional CD and DVD jewel cases. Adhesively secured to the buzzer is a lid sensor 3 in communication with the microcontroller that detects unauthorized opening of the jewel case lid. The sensor includes a small housing 4 having a pair of spaced trigger arms 5 extending therefrom. The arms each include a central notch 7 that cooperates with the other to form an ovate opening 6. A terminus on an upper arm has an electrical contact 8 on its lower surface for selectively engaging a similar contact 9 on the upper surface of the other arm. A nodule 10 on the upper surface of the upper arm terminus engages a jewel case lid to maintain engagement of the contacts. The contacts are in communication with the alarm module such that, if the contacts separate, the buzzer is activated.

A magnetic switch 11 arms the sensor allowing it to detect unauthorized entry into the jewel case. The switch includes a magnetically-operated pin 12 that is extended from and retracted within a casing. The casing is positioned such that, when the pin is extended, it fits within the opening formed by the trigger arm notches to prevent the contacts from separating.

An arming station having an electromagnet is positioned at a strategic Location within a retail outlet, such as near a cash register. When the jewel case is first closed and sealed with security tape, the case is scanned by the arming station to retract the pin. The case lid firmly engages the nodule to maintain the contacts in engagement thereby arming the alarm. If an unauthorized user opens the jewel case without first deactivating the alarm at the arming station, the triggers arms will automatically separate instructing the microprocessor to activate the buzzer. When a consumer legitimately purchases the disc, a cashier or other worker scans the jewel case to extend the pin into the opening formed between the trigger arms to prevent alarm activation.

The above-described device is not limited to the exact details of construction And enumeration of parts provided herein. Furthermore, the size, shape and materials of construction of the various components can be varied.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

I claim:

1. An audible alarm device for conventional CD/DVD cases, software cases, and product boxes presented, in the preferred embodiment, embracing the scope and spirit of the device comprising a housing or casing structure couching locking agents; the housing combined with a control unit of said audible alarm device can distinguish the position of said locking agents and means for a sound production agent releases an alert if contact is broken; a pluracy of batteries supply the power source; there are a multitude of composite, dimension, and placement possibilities for the audible alarm device and its components; said audible alarm device is not limited to the preferred embodiment as presented.

2. The audible alarm device of claim 1 wherein said device is an in-store theft deterrent device whereby providing means for securing digital data storage discs or goods in cases and product boxes thereby preventing unlawful appropriation of said goods presented in an inexpensive, re-armable, easily constructed, simple device constructed of readily obtained materials designed to retain the disc on the center hub clips of the CD/DVD case in the usual manner and to fit snugly within the central indention of digital data storage cases which is approximately 1.00″ in diameter by 0.100″ deep; the center of the CD/DVD case is approximately 0.500″ in diameter by 0.200″ deep; the audible alarm device is disposed on the underside of product box lids, whereby such placement reduces or eliminates the need for additional protective cases or an alarm device in which digital data storage discs or goods are inserted or spider wrapped to reduce in-store theft of goods; said audible alarm device is adhered unobtrusively on the circuit board disc which contains all components of the device whereby the device may easily be inserted in the package or product box for digital data storage discs and various other types of goods.

3. The audible alarm device of claim 1 wherein the goods are data carrying devices comprising:
a. the goods are devices containing data selected from the group consisting of audio data, video data, a combination of audio and video data, computer executable data and instructions, video games and instructions, educational and instructions,
b. the goods comprise using or placing the alarm for a digital storage disc in a case or product box selected from the group consisting of digital data storage disc jewel cases, DVD cases, software cases and a multitude of product boxes.

4. The composition of the housing structure of claim 1 comprising:
the housing is very thin and small, is preferably plastic, and is in a predetermined markedly rectangular shape; said housing or casing is placed in a horizontal orientation and may be adhered to the base of the control element of claim 1.

5. The housing or casing of claim 1 couches the locking and unlocking mechanisms of claim 1 of the audible alarm device of claim 1 comprising:
a. a pair of rods or leaves,
b. a retractable orienting pin,
c. an arming rod,
d. a sensor unit,
e. an electrical relaying medium or element,
f. an amplifier,
g. an electromagnet,
h. there are a multitude of composition, dimension, and placement possibilities concerning the locking and unlocking mechanisms; said locking and unlocking mechanisms are not limited to the preferred embodiment.

6. The audible alarm device of claim 1 wherein a pair of predetermined, elongated, narrow leaves form arming rods of claim 5 of said locking and unlocking mechanisms of claim 1 comprising:
a. configuring said locking and unlocking mechanisms to change orientation of the locking and unlocking contacts within said control element of claim 1,
b. orientating the rods of claim 5 or retaining members within said housing of claim 1 thereby configuring the unattached rod ends [trigger arms] of claim 1 in an elongated horizontal orientation so as to configure a hole formed by notches on the unattached ends of the arming rods of claim 5.
c. adhering one end of the rods of claim 5 of the locking and unlocking mechanisms of claim 1 within the housing or casing of claim 1,
d. the upper ends of the rods of claim 5 have a nodule on the surface whereby said rods may establish contact with the lid surface and the control element of claim 1,
e. maintaining contact with said control element of claim 1 constitutes coating the unattached upper rod of claim 5 terminus contacts with said electrical relaying medium of claim 5,
f. orientating a retractable orienting pin of claim 5 within an ovate hole or notch formed by the arming rods of claim 5,
g. whereby the absence of the pin of claim 5 within said notch releases or breaks the control element of claim 1 contact,
h. wherein the sensor unit of claim 1 senses loss of contact with said control element of claim 1 upon said pin removal thus initiating activation of the audible alarm module of claim 1 thereby sounding the alarm,
i. The presentation presented is not limited to the described embodiment;
a multitude of composites, dimensions , and placements are possible.

7. The audible alarm device of claim 1 comprising said housing or casing and further including an electromagnetic locking device of claim 1.

8. The audible alarm device of claim 1 wherein said electromagnetic locking device comprises said locking and unlocking mechanisms and further including a switch of claim 1.

9. The audible alarm device of claim 1 wherein said electromagnetic locking device comprises said locking and unlocking mechanisms, said switch , and further including a control element of claim 1 or sensor unit of claim 1.

11. The audible alarm device of claim 1 wherein said electromagnetic locking device comprises said locking and unlocking mechanisms of said switch, said control element or said sensor unit, and further including an arming control of claim 1.

12. The arming control of said audible alarm of claim 1 comprises communication relays determining the switch position by said switch of claim 1 configuration microcontroller of claim 1 including a circuit board of claim 1 configured to regulate communication with all parts of the audible alarm device of claim 1 and regulation means for electrical communication relay of impulses via leaves and contacts located on the unattached ends of the arming rods of claim 5 to the switch of claim 1.

13. The audible alarm device of claim 1 wherein said electromagnetic locking device comprises said locking and unlocking mechanisms, said switch, said sensor unit, and said arming control of claim 1, and further including a microcontroller of claim 1.

14. The microcontroller of claim 1 comprises a standard 0.032″ FR4 double sided printed circuit board smart enough to meet the tasks wherein the PCB sits directly on the plastic case which acts as an insulator.

15. The microcontroller of claim 1 controls the components of the audible alarm device of claim 1 and is circular in shape so as to facilitate placement within the central indention of jewel cases.

16. The audible alarm device of claim 1 wherein said electromagnetic locking device of claim 1 comprises said locking and unlocking mechanisms, said switch, said sensor unit, said arming control, said microcontroller of claim 1, and further including a circuit board of claim 1.

17. The audible alarm device of claim 1 wherein said electromagnetic locking device of claim 1 comprises said locking and unlocking mechanisms, said switch, said sensor unit, said arming control, said microcontroller, said circuit board of claim 1 and further including a power source of claim 1.

18. The audible alarm module of claim 1 comprising said housing, said electromagnetic locking device, said microcontroller, said power source, and further including an audible alarm device of claim 1.

19. The audible alarm module of claim 1 is formed of a circuit board of claim 1 having an alarm sound producer or amplifying device of claim 1 comprising a piezo buzzer, said power source, and said microcontroller of claim 1.

20. Said audible alarm module's piezo buzzer is configured to emit a minimum 80 dB sound at 4 KHz but can be adapted to include any frequency level desired.

21. The audible alarm device of claim 1 comprising said housing, said sensor, said electromagnetic locking device, said microcontroller, said circuit board, said power source, said audible alarm of claim 1, and further including an inductive element of claim 1 as means for electrical impulse relay to the alarm module of claim 1; the audible alarm device of claim 1 and claim 5 is not limited to the preferred embodiment presented; numerous modifications and adaptations are possible within the scope and spirit of the device.

22. The audible alarm device of claim 1, in the preferred embodiment, one or more components comprising: said housing, said sensor module, said electromagnetic locking device, said microcontroller and sensor, said circuit board, said audible alarm module, said power source, and said inductive element; the audible alarm for a digital storage disc of claim 1 and claim 5 has a multitude of composite, dimension, and placement possibilities and is not limited to the presented preferred embodiment.

23. The inductive elements or coated contacts of claim 1 act as means for providing electrical relays to the audible alarm device of claim 1 and are appended to the locking member of each arming rod of claim 5 whereby retaining said locking member in the contracted position wherein the sensor magnetic lock button holds the sensors together.

24. The audible alarm device of claim 1 activation and deactivation method comprising:
a. a method for activation of said audible alarm device by retracting said pin from said sensor by advancing a strong electromagnetic force to the right over the bobbin, and
b. a method for deactivation of said audible alarm device by advancing said pin into the sensor loops to retain the sensor contacts in a contracted position by advancing a strong electromagnetic force left over the bobbin.

25. A method for installation and use of the audible alarm device of claim 1 comprising:
a. place the audible alarm device in the central indention of the jewel case or dispose on the underside of the product box lid,
b. insert the digital data storage disc or goods into the package or product box,
c. add magnetic security device strips, if desired, prior to closing the lid,
d. close the lid and seal with security tape around the outside of the package or product box,
e. the package or product box is shrink-wrapped,
f. said audible alarm device is then armed at an arming station by the preferred arming method comprising:
1. said electromagnet of claim 1 retracts said pin while the case lid or product box lid firmly engages said nodule of claim 1 to maintain said contacts in engagement,
2. the audible alarm device of claim 1 activation occurs by passing the package or product box to the left over a strong electromagnetic force,
3. the audible alarm device of claim 1 deactivation occurs by passing the package or product box to the right over a strong magnetic force at a de-magnetizing station at the check out stand,
4. once the package or product box has been scanned, the package or box is ready to shipped to the vendor.

26. The audible alarm device of claim 1 features of the alarm for a digital data storage disc comprising:
a. the audible alarm device of claim 1 is an economical, simple-in-design, device designed for securing digital data storage discs or goods in conventional jewel cases and product boxes,
b. the audible alarm of claim 1 design allows it to be inserted into packages or boxes as a means for preventing unlawful appropriation of digital data storage discs or goods whereby decreasing loss while increasing vendor revenue, yet the design allows for re-arming of the alarm by vendors, if desired, and the design also permits customer removal and disposal,
c. The audible alarm device of claim 1 is easy to manufacture using the preferred embodiment, all components of said alarm are easily obtained and are economical in nature whereby the use of the alarm provides an economical solution for loss prevention aspects for vendors whereby vendors may add the alarm unit without affecting profitability thereby reducing or eliminating loss from pilfering by thieves attempting to shoplift while in the store; the sounding of the alarm alerts store personnel who respond to the alert thereby preventing the thief from absconding with the goods.
the audible alarm device of claim 1 eliminates the need for additional separate theft prevention storage cases and spider wraps whereby providing an added cost benefit; the module production cost is small enough to allow the alarm unit to be added to the case or the product box without affecting profitability,
e. An additional benefit of the audible alarm device of claim 1 is the adaptability of the alarm; while the embodiment described herein is limited to digital data storage discs or goods, it should be apparent there are many adaptations possible which are in the scope and spirit of the audible alarm device including a multitude of composites, dimensions and placements; said audible alarm device of claim 1 and claim 5 is not limited to the preferred embodiment.
